(19) United States
(12) Patent Application Publication
(10) Pub. No.: US 2015/0367558 A1
(43) Pub. Date: Dec. 24, 2015

(54) Method for Nano-Structuring Polmer Materials Using Pulsed Laser Radiation in a Reactive Atmosphere

(71) Applicant: Airbus Defence and Space GmbH, Ottobrunn (DE)

(72) Inventors: Erhard BRANDL, Eitensheim (DE); Ante KURTOVIC, Paderborn (DE); Tobias MERTENS, Muenchen (DE)

(21) Appl. No.: 14/434,959

(22) PCT Filed: Oct. 10, 2013
(86) PCT No.: PCT/DE2013/000584

§ 371 Date: Aug. 28, 2015

(30) Foreign Application Priority Data
Oct. 11, 2012 (DE) 10 2012 019 919.8

(51) Int. Cl. B29C 59/16

(52) U.S. Cl. CPC B29C 59/16

(57) ABSTRACT

In a method for producing a surface with a solid polymeric material which has surface structures having dimensions in the sub-micrometer range, the untreated surface on which the structures are to be produced and which is accessible to laser irradiation is scanned with a pulsed laser beam one or more times in a reactive gas atmosphere in such a manner that adjacent light spots of the laser beam have unbroken abutment or overlap with one another, and a certain range of a predetermined relation between method parameters is met, whereby the surface is chemically modified.

### FIELD OF THE INVENTION

The invention relates to a method for producing a surface of a workpiece comprising a solid polymeric material, the surface having chemically modified surface structures having dimensions in the sub-micrometer range opposite to the original surface.

### BACKGROUND OF THE INVENTION

The wettability with and adhesion of liquid, semi-solid, and solid substances on the surface of workpieces such as those made of ceramic, glass, plastic, or carbon is highly dependent on the surface texture thereof. This is of great importance in treatments with or application and adhesion of materials such as an adhesive, paint, solder, bone cement, sealant, bonding agent, coatings to protect against chemical or heat exposure, or even biological tissue. Degreasing and other forms of further purification as well as mechanical roughening enhance the wettability and adhesion to a certain degree. As the roughness of the surface increases, i.e., as the surface becomes greater and more structured, consequently increasing the chemical/mechanical anchoring of the materials needing to be applied, however, these properties are still significantly improved.

Patent document EP 0 914 395B1, incorporated herein by reference, describes a method for treating an unpurified metal surface comprising treating the surface with an organosilane and exposing the surface to a laser.

The invention addresses the problem of developing a simple method obviating as much as possible the need to use chemicals to produce a favorable roughness on solid polymeric surfaces.

### SUMMARY OF THE INVENTION

The invention relates to a method for producing a surface of a workpiece, by which surface structures having dimensions in the micrometer range are generated, wherein the surface comprises at least one solid polymeric material with which an original surface comprising the material which does not yet have surface structures having dimensions in the sub-micrometer range and is accessible to irradiation with a laser beam, and on which the surface structures are to be produced, is completely scanned with a pulsed laser beam one or more times in such a manner that adjacent laser scanning spots have unbroken abutment or overlap with one another, wherein the wavelength of the laser λ is about 100≦λ≦about 11,000 nm, and the following conditions are met: about 0.5≦ε≦about 1350 with

$$ɛ = \frac{{P}_{P} \cdot \sqrt{{P}_{m}} \cdot f \cdot α \cdot \sqrt{t} \cdot \sqrt{κ}}{{d}^{2} \cdot \sqrt{v} \cdot \sqrt{{c}_{P}}} \cdot {10}^{4} \qquad ( Equation 1 )$$

where:
Pₚ: Peak pulse power of the emitted laser radiation [kW]
Pₘ: Mean power of the emitted laser radiation [W]
f: Repetition rate of the laser pulses [kHz]
α: Absorption of the laser radiation by the irradiated material [%] under standard conditions
t: Pulse length of the laser pulses [ns], wherein t is ≧about 0.1 ns
κ: Specific thermal conductivity [W/mK] under standard conditions and averaged over the different spatial directions
d: Diameter of the laser beam on the workpiece [μm]
v: Scanning speed on the workpiece surface [mm/s]
cₚ: Specific heat capacity [J/kgK] under standard conditions
wherein the atmosphere in which the method takes place is gas or a gas mixture that is reactive with respect to the surface under the method conditions, the aforementioned material that is comprised by the surface being thereby chemically modified in or after the scanning of the pulsed laser beam with respect to the composition thereof prior to the scanning with the laser beam.

Also described is a workpiece comprising a surface that comprises at least one solid polymeric material with which the surface has a structure that can be produced as per the above-stated method.

Finally, also described is the use of the aforementioned workpiece or with a surface prepared according to the aforementioned method in the joining or coating of the workpiece with a similar or different material with or without an adhesive.

### BRIEF DESCRIPTION OF THE DRAWINGS

FIGS. 1A and 1B are each top views of an untreated surface of polyether ether ketone (PEEK);

FIGS. 2A and 2B are plan views, based on an inert argon atmosphere, of nanoporous PEEK surface layers having a high adhesive strength formed on the substrate;

FIGS. 3A and 3B are plan views, based on an oxygen atmosphere, of nanoporous PEEK surface layers having a high adhesive strength formed on the substrate;

FIGS. 4A and 4B are plan views, based on an nitrogen atmosphere, of nanoporous PEEK surface layers having a high adhesive strength formed on the substrate;

FIGS. 5A and 5B are images illustrating changes in the PEEK surface layer;

FIGS. 6A and 6B are each top views of an untreated surface of epoxy resin;

FIGS. 7A and 7B are plan view images, based on an argon atmosphere, of nanoporous epoxy resin surface layers having a high adhesive strength formed on the substrate;

FIGS. 8A and 8B are plan view images, based on an nitrogen atmosphere, of nanoporous epoxy resin surface layers having a high adhesive strength formed on the substrate;

FIGS. 9A and 9B illustrate changes of the epoxy surface layer based on the oxygen atmosphere;

FIGS. 10A and 10B illustrate changes of the epoxy surface layer based on the nitrogen atmosphere;

FIGS. 11A and 11B are each top views of an untreated surface of polyurethane;

FIGS. 12A and 12B are plan view images, based on a vacuum, of nanoporous epoxy surface layers having a high adhesive strength formed on the substrate;

FIGS. 13A and 13B are plan view images, based on an oxygen atmosphere, of nanoporous epoxy surface layers having a high adhesive strength formed on the substrate;

FIGS. 14A and 14B are plan view images, based on a nitrogen atmosphere, of nanoporous epoxy surface layers having a high adhesive strength formed on the substrate;

FIGS. 15A and 15B illustrate changes in the polyurethane surface layer.

### DETAILED DESCRIPTION OF THE DRAWINGS

As mentioned above, the roughening or structuring in the sub-micrometer range of surfaces is essential for a favorable adhesion of adhesives, coatings, biological tissue, and other such coatings, such as with heat insulation layers and metallic bonding agent layers.

It has now surprisingly been found that only radiating one or more times with a pulsed laser beam under the conditions mentioned in the above-described method makes it possible to produce sub-microstructured (or nanostructured) surfaces of solid polymeric materials, which ensure excellent adhesion of, for example, adhesives, coats, solders, sealants, bone cements, bonding agents, or biological tissue and of coatings, such as coatings to protect against chemical or heat exposure.

If two workpieces having a surface as described above or such a workpiece having another material are connected to one another under pressure, then it is also possible to enhance the adhesion of these conjoined materials if nanostructures have been produced according to the invention on at least one side.

The surfaces that have been provided with surface structures as produced according to the invention may, depending on the embodiment, generally comprise open-pore, fissured, and/or fractal-like nanostructures, such as open-pore peak-and-valley structures, open-pore undercut structures, and cauliflower-like or bulbous structures. At least about 80%, preferably at least about 90%, even more preferably about 95% of elevations have a height of <1 μm, shifting, for example, in the range of about 10 nm to about 200 nm. At least about 80%, preferably at least about 90%, even more preferably at least about 95% of the interstices also have widths of <about 1 μm, for example, about 10 nm to about 50 nm. The length of the “valleys” in peak-and-valley structures is, however, often more than about 1 μm.

Such nanostructures generally cover at least about 90%, preferably at least about 95% of the polymer surface, calculated as level. Under optimally adjusted process parameters (especially repetition rate, scanning speed, and focus diameter), the nanostructure can even cover about 100% of the polymer surface calculated as level. In the case of composite materials that contain an inorganic or polymeric matrix as well as polymeric fibers present at the surface, or in the case of green preforms that contain a polymeric matrix and polymeric fibers present on the polymer surface, it may be advantageous to structure the matrix and the fibers separately or to structure only the matrix or only the fibers. In this case, the above-mentioned surface may refer to the surface solely of the matrix or solely of the fibers.

The original surface may be scanned with the laser beam one or more times in succession with the same process parameters and the same laser beam, or with different process parameters with the same laser, or with different laser beams with the same process parameters, or with different process parameters. Repeated scanning potentially makes it possible to produce an even finer structure.

It should be mentioned that naturally it is only possible to treat those surface regions that can be reached by a laser beam. Regions that lie completely “in the shadow” (for example, with undercut geometries) cannot be structured in the manner described herein.

Usually, the original surface that comprises at least one solid polymeric material (hereinafter sometimes referred to as the surface material according to the invention) is not pre-treated or purified prior to being scanned with the laser beam, although so doing is not excluded; for example, the surface may be cleaned with a solvent. In general, differently than is described in patent document EP 0 914 395 B1, the original surface is not treated before the scanning with a bonding agent such as, for example, a silane bonding agent, a titanate such as titanium tetraisopropylate or titanium acetylacetonate, a zirconate such as zirconium tetrabutylate, zirconium aluminate, a thiazole, a triazole such as 1H-benzotriaozle, a phosphonate, or a sulphonate, in order to increase the adhesive strength to a material needing to be bonded or applied to the surface. Even after scanning, typically no bonding agent is applied in order to increase the adhesive strength before the surface has been bonded to another surface and/or before a coating such as with an adhesive, pain, solder, bone cement sealant, sealant, or biological tissue, and/or another such coating that entails, for example, a protective coating, dirt-repellent or anti-adhesion coating, coating to protect against chemical or heat exposure, or other such functional coatings has been allowed to adhere and/or has been applied.

The solid polymeric material comprised by the surface may refer to any solid organic polymers and mixtures thereof.

Organic polymers are usually divided into thermoplastics, elastomers, thermoplastic elastomers, and thermosetting plastics.

Thermoplastics are polymeric materials that are hard or soft at the temperature of use and that possess a flow transition range above the temperature of use. Members of this class include all plastics composed substantially of linear or thermolabilely crosslinked polymer molecules. Examples are polyolefins such as polyethylene and polypropylene, polyesters, polyether ether ketones, polyacetals, polycarbonates, polystyrenes, thermoplastic polyurethanes, and thermoplastic ionomers and copolymers of the monomer units underlying these compounds, such as block copolymers of styrene and polyolefins.

Elastomers are polymers that behave in a rubber-elastic manner, which can be repeatedly stretched at room temperature up to twice the length thereof and immediately return to approximately the initial length thereof once the forcing required for the stretching is suspended. Elastomers are high-polymeric materials that are crosslinked in a wide-meshed manner up to the decomposition temperature, and that behave in an energy-elastic at low temperatures and do not undergo viscous flow even at high temperatures, but rather are rubber-elastic at 20° or lower until the decomposition temperature. The irreversibly crosslinked elastomers are generally produced by vulcanization or crosslinking of natural and synthetic rubbers (which are non-crosslinked rubber-elastic polymers). Exemplary members of the class of the numerous rubbers from which elastomers are produced by crosslinking include (just to name a few) acrylate rubber, polyester urethane rubber, polyether urethane rubber, peroxidically cross linked ethylene propylene copolymer, styrene-butadiene rubber, polybutadiene, epichlorohydrin and ethylene vinyl acetate copolymer.

Thermoplastic elastomers (TPEs) ideally offer a combination of the performance properties of elastomers and the processing properties of thermoplastics. This can be achieved if the corresponding plastics have present therein simultaneously soft and elastic segments having high elasticity and a low glass transition temperature as well as hard, crystallizable segments having low elasticity, a high glass transition temperature, and a high tendency to form associates (crosslinking) Examples counted among the thermoplastic elastomers include styrene-butadiene (or isoprene or ethylene butylene) block copolymers, elastomeric alloys, polyurethanes, polyether esters, and polyether amides.

Thermosetting plastics are plastics produced from curable resins. They are high-polymeric materials that are crosslinked in a close-meshed manner up until the decomposition temperature, and that are energy-elastic at low temperatures and do not undergo viscous flow even at high temperatures, but rather behave elastically from 50° upwards and the decomposition temperature with very limited deformability. Members of the class of thermosetting plastics include epoxy resins, diallyl phthalate resins, urea formaldehyde resins, phenol formaldehyde resins, melamine formaldehyde resins, polyacrylates, and unsaturated polyester resins.

The entire polymer surface or even the matrices of composite materials may be made from these materials.

Examples of polymers for producing polymeric organic fibers or synthetic fibers that can be incorporated into composite materials are elastane, polytetrafluoroethylene, polyacrylic, modacrylic, polyamide, aramid, polyvinyl chloride, polyvinylidene chloride, polyester, polyethylene, polypropylene and polyvinyl alcohol. The fibers may be short, long, or continuous fibers, depending on the need.

The solid polymeric material may also refer to inorganic-organic polymers. Examples include polysilanes, polycarbosilanes (e.g. allyl-hydridopolycarbosilane), polysilazanes, and polysiloxanes. Ceramic green preforms can be produced from these inorganic-organic polymers. They may also be used as polymer precursors for ceramic fibers. Firing is followed by the emergence, as crystalline ceramic materials, of SiC—, C— and SiO₂ ceramic materials from polysilanes and polycarbosilanes, of SiC— and Si₃N₄ ceramic materials from polysilazanes, and of SiC—, C— and SiO₂— ceramics from polysiloxanes. Even amorphous ceramics having Si—C—O—, Si—N—C—, and Si—O—C— bonds can be produced from green preforms and fiber precursors containing these inorganic-organic polymers, through firing.

The green preforms containing the above-named inorganic-organic polymers for ceramics and for fibers and/or carbon- and/or boron nitride-containing composite materials having a ceramic, plastic, and/or carbon matrix may be provided with a surface structure produced according to the invention.

The aforementioned composite materials entail in particular the green preforms for laser irradiation according to the invention that are produced through the polymer infiltration technique (see, for example, W. D. Vogel et al, Cost effective production techniques for continuous fibre reinforced ceramic matrix composites, Ceramic Processing Science and Technology, 51, 1995, S. 225-259, and A. Mühlratzer, Entwicklung zur kosteneffizienten Herstellung von Faserverbundwerkstoffen mit keramischer Matrix, Porceedings Verbundwerkstoffe Wiesbaden, 1990, S. 22.1-22.39, both incorporated herein by reference). This method involves crosslinking pyrolyzable precursors for the matrix, which are infiltrated into the fibers or fiber precursors, at moderate temperatures, e.g. 100° C. to 300° C., and pressures in the range of, for example, 10 to 20 bar, so that a firm bond is produced from the crosslinked polymer and fibers or fiber precursors. The product may then be irradiated with a laser, wherein nanostructures emerge on the surface. When the nanostructures are being produced by the action of the laser beam under a reactive atmosphere, the green preform is even further cured and even chemically modified on the surface. In this state, the surface of the green preform is then further treated as shall be described below, e.g., coated with an adhesive and joined to another surface. Only then is the pyrolysis of the precursor material made into a ceramic.

The method is carried out in an atmosphere that contains a reactive gas by which the surface material according to the invention is chemically modified. Members of the reactive gases in which the method can be carried out include, for example, inorganic gases or gas mixtures, such as hydrogen, air, oxygen, nitrogen, halogens, carbon monoxide, carbon dioxide, ammonia, nitrogen monoxide, nitrogen dioxide, dinitrogen monoxide, sulfur dioxide, hydrogen sulfide, boranes and/or silanes (e.g. monosilane and/or disilane).

Organic gases or gases having organic groups may also be used. These include, for example, lower, optionally halogenated alkanes, alkenes and alkynes such as methane, ethane, ethene (ethylene), propene (propylene), ethyne (acetylene), methyl fluoride, methyl chloride, and methyl bromide, as well as methyl amine and methylsilane. A mixture of an inorganic gas and an organic gas or an organic group-containing gas may also be used.

If a gas mixture is present, it suffices for a gas constituent thereof or a mixture of a plurality of gas constituents to be a reactive gas, in which the remainder may be an inert gas, generally a noble gas. The concentration of the reactant gas or gas mixture may range from a few ppb, e.g., 5 ppb, up to more than 99 vol %.

The selection of the reactive gas or gas mixture depends, as a matter of course, on the intended modification of the surface material according to the invention. If an oxide-containing surface is to be reduced in order, for example, to introduce hydroxide groups, then a reducing gas such as hydrogen will naturally be used as the reactive gas (optionally in a mixture with an inert gas). For oxidation of the surface, however, then, for example, an oxygen-containing gas will be considered. A person skilled in the art would know or could easily come to know, through simple preliminary testing, which reactive gas must be selected in order to consequently achieve a desired effect with a given surface material according to the invention.

The pressure of the reactive gas or gas mixture, which optionally consists only of a reactive gas content, lies generally in the range of about 10⁻⁶ bar to about 5 bar. It is possible to work at gas temperatures that, outside of the laser beam, lie generally in the range of about −50° C. to about 100° C. Naturally, much higher temperatures can occur within the laser beam.

Once performed, a chemical modification of a given surface material according to the invention can be ascertained through suitable analytical methods such as X-ray photoelectron spectroscopy (XPS), energy dispersive X-ray analysis (EDX), FTIR spectroscopy, time-of-flight secondary ion mass spectrometry (TOF-SIMS), electron energy loss spectroscopy (EELS), high-angle annular dark field (HAADF), or near infrared spectroscopy (NIR).

ε, which must arise from the parameters or the above-given equation, so that the surface structuring that is the target of the invention is produced, has values that preferably lie at about 0.5≦ε≦about 1,350, preferably at about 0.6≦ε≦about 1,300, more preferably at about 0.7≦ε≦about 1,250.

The laser wavelength λ is about 100 nm to about 11000 nm. As the laser, it would be possible to use a pulsed solid-state laser such as Nd:YAG (λ=1064 nm or 533 nm or 266 nm), Nd:YVO₄ (λ=1064 nm), a diode laser having, for example, λ=808 nm, a gas laser such as an excimer laser having, for example, KrF (λ=248 nm) or H₂ (λ=123 nm or 116 nm), or a CO₂ laser (10,600 nm).

The specific heat capacity cₚ under standard conditions and the specific thermal conductivity κ, as averaged over the different spatial directions, under standard conditions of the material according to the invention which are to be employed for ε in the above-mentioned expression are material properties of the irradiated material according to the invention.

The absorption of the irradiation a under standard conditions depends on the wavelength. Due to this property of the absorption, the wavelength λ of the laser radiation enters indirectly into the above equation. The absorption of the irradiation at a particular wavelength can be determined with spectroscopic methods that would be known to a person skilled in the art. It is also a material property of the irradiated material according to the invention.

Preferred parameters of the method of the invention shall be given below. It must be emphasized that all of the parameters may be varied independently of one another.

The pulse length of the laser pulses t is preferably about 0.1 ns to about 900 ns, more preferably about 0.1 ns to about 600 ns.

The peak pulse power of the emitted laser radiation Pₚ is preferably about 1 kW to about 1,300 kW, more preferably about 3 kW to about 650 kW.

The mean power of the emitted laser radiation Pₘ is preferably about 0.2 W to about 28,000 W, more preferably about 1 W to about 8,000 W.

The repetition rate of the laser pulses f is preferably about 1 kHz to about 3,000 kHz, more preferably about 5 kHz to about 950 kHz.

The scanning speed on the workpiece surface v is preferably about 30 mm/s to about 8,000 mm/s, more preferably about 200 mm/s to about 7,000 mm/s.

The diameter of the laser beam on the workpiece d is preferably about 20 μm to about 4,500 μm, more preferably about 50 μm to about 3,500 μm.

It is believed—though without the wish to be bound to a theory—that the physical mechanism could be as follows: in the range according to the invention, a part of the substrate optionally under decomposition turns into a vapor and/or plasma phase due to the incidence of the laser radiation on the substrate surface. Possibly accompanying elements of the substrate (e.g. contaminants) are also converted into the vapor and/or plasma phase. Another part of the substrate is heated, and optionally the viscosity thereof is lowered (preferably to a molten phase). The vapor or plasma phase condenses and/or solidifies under a reaction with the reactive gas through homogeneous nucleation in the atmosphere (especially through coagulation and coalescence) or heterogeneous nucleation at the substrate surface into liquid and/or solid nanoparticles. The nanoparticles precipitating onto the hot and optionally low-viscosity substrate surface are firmly bonded to the substrate surface by the subsequent cooling of the substrate surface, which runs slower than the nanoparticle precipitation. The result is an open-pored, rugged surface having dimensions in the sub-micrometer range.

The surfaces produced according to the invention, which comprise the above-described nanostructures, provide excellent adhesion of adhesives, paints, and other such coatings. If nanostructures have been produced according to the invention on at least one workpiece having a surface that comprises the surface material according to the invention, then it is possible to join together with satisfactory adhesion two such workpieces or one such workpiece with another workpiece having a surface made of another material, by merely conjoining same under elevated pressure at room temperature or at elevated temperatures.

The surfaces according to the invention may, however, also be nanostructured for purposes other than improving adhesion. Generally, therewith, it is possible to alter the physical and/or chemical interaction of the surface with light or matter. For example, the nanostructuring may be accompanied by an alteration of the color or emissivity, or the electrical conduction of the surface. It is also possible to use phenomena such as increasing the number of points at which crystal nuclei or bubble nuclei can be formed. An everyday example would be a champagne glass made of PET, as is frequently used for one-time use, that has a nanostructured surface leading to an improved foaming behavior of the drink.

An example of particularly preferred workpieces having a surface produced according to the invention is ceramic or ceramic-composite prostheses and ceramic or ceramic-composite implants. The nanostructured surfaces thereof ensure that the biological materials in the body, with which they are to fuse, stick superbly to the surfaces.

The use of a workpiece having a surface produced according to the invention with or without chemical modification in the coating of the workpiece with a similar or different material with or without an adhesive shall be described herein. The coating may be any suitable coating for a surface material having been treated according to the invention, and may be applied through any suitable manner. Selected examples include solders, coatings applied through thermal and non-thermal spraying, coatings via wet chemistry or a vapor (e.g. PVD), coatings with vitreous materials, ceramics, and organic materials, including biological materials or biological tissues, which are optionally produced directly on the surface produced according to the invention.

The surface of the green preform may, prior to being fired, optionally be provided with adhesives, paints, and other such coatings and/or is joined to the surface of a second workpiece. The firing is carried out next. This may then be advantageous, for example, with respect to the joining of a fired ceramic to a coating or a second workpiece if so doing reduces stresses at the interface or enhances the strength.

The following examples illustrate the invention without limiting it.

### EXAMPLES

Examples 1 to 3 illustrate the production of surface structures according to the invention (with comparative examples) with a thermoplastic (PEEK), a thermosetting plastic (epoxy resin), and a thermoplastic elastomer (polyurethane), respectively.

### Example 1

### Surface Structuring of Polyether Ether Ketone

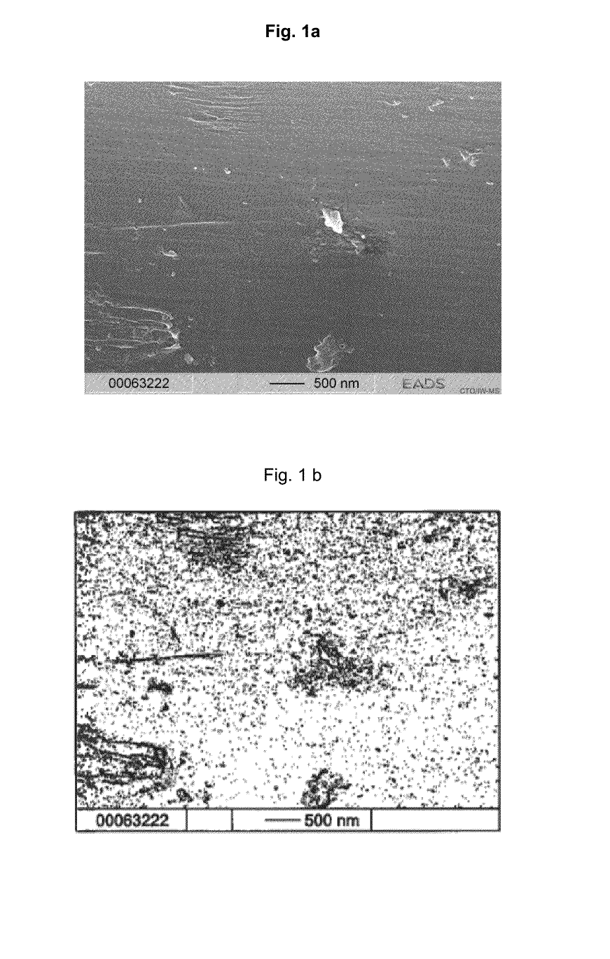

FIGS. 1a and 1b illustrate a top view of an untreated surface of polyether ether ketone (PEEK), a thermoplastic.

Such surfaces were scanned with pulsed laser radiation under the following test conditions, without having been pre-treated.

### Test Conditions A

The surface was scanned twice with a pulsed laser (λ=532 nm) in an inert argon atmosphere, in an oxygen atmosphere, and in a nitrogen atmosphere at ambient pressure and temperature.

The method parameters and material constants were:

Pₚ: 27 kW; Pₘ: 33 W; f: 15 kHz; α: 45%; t: 82 ns; κ: 0.25 W/mK; d: 100 μm; v: 500 mm/s; cₚ: 3000 J/kgK.

The value of ε=387, as calculated according to equation 1, lies within the range according to the invention.

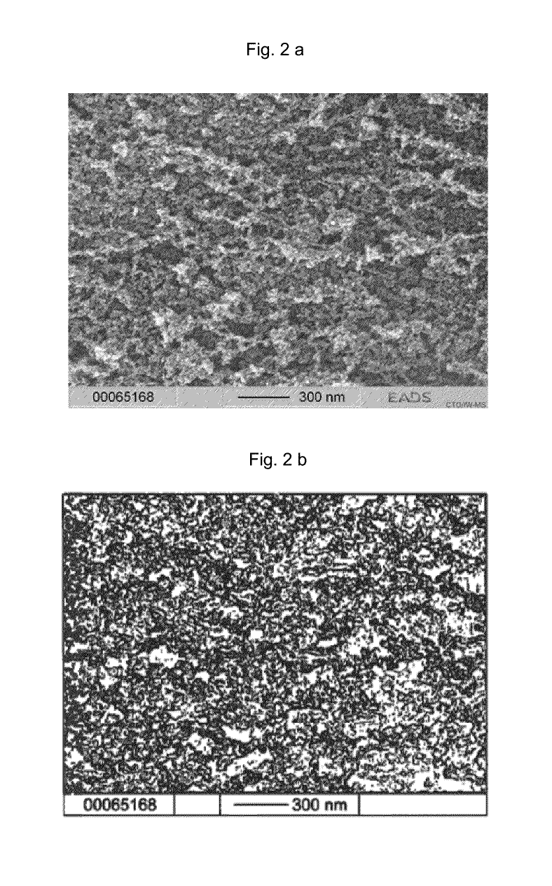

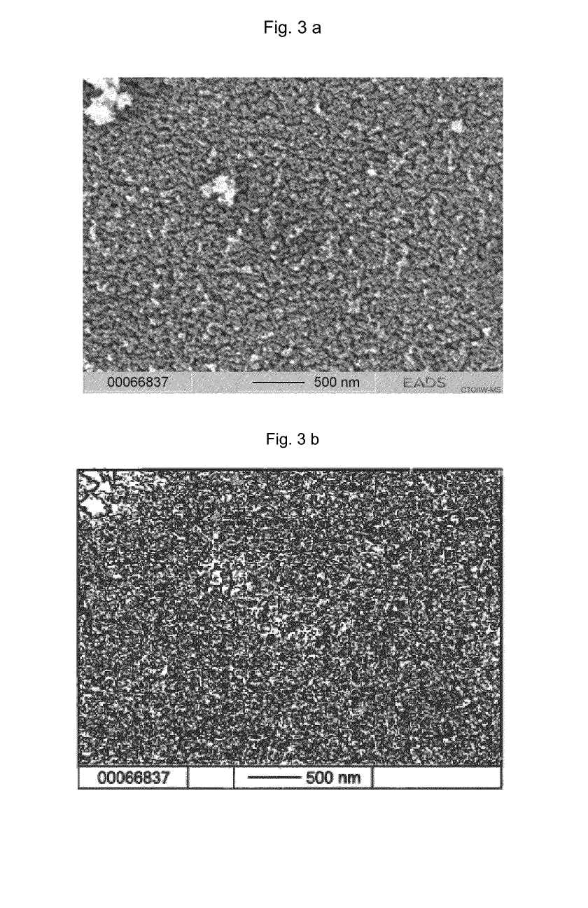

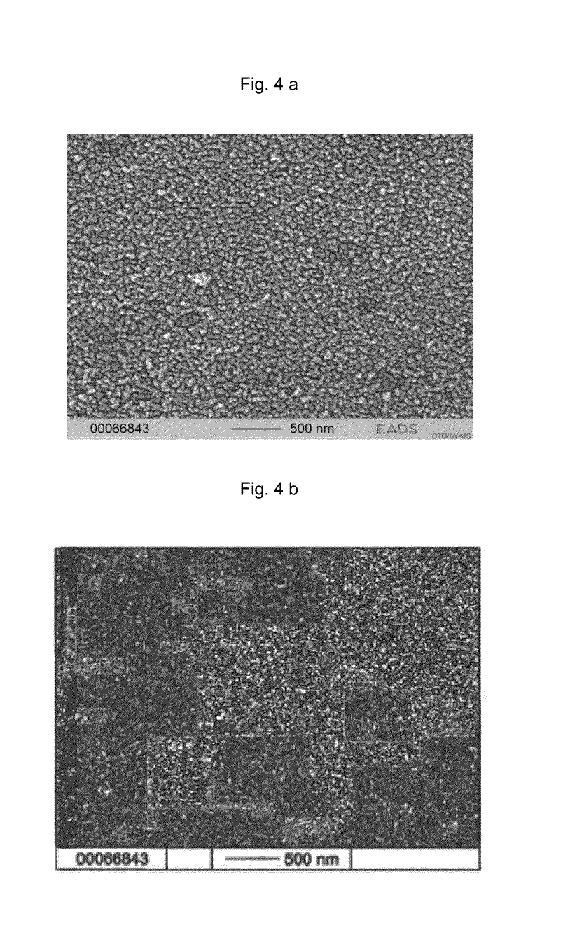

As is illustrated in plan view in the SEM images of FIGS. 2a and 2b (inert argon atmosphere), FIGS. 3a and 3b (oxygen atmosphere), and FIGS. 4a and 4b (nitrogen atmosphere), the result is nanoporous PEEK surface layers that had a high adhesive strength to the substrate.

The elemental composition of the surfaces was analyzed after the laser treatment by means of XPS. The results are summarized in table 1 below.

TABLE 1

| | at % | | | | |
|---|---|---|---|---|---|
| Example 1 | C | N | O | S | Si |
| untreated | 75.7 | 6.1 | 17.3 | 0.6 | 0.3 |
| Laser treatment under argon | 80.2 | 4.3 | 15.5 | — | — |
| Laser treatment under oxygen | 61.2 | 4.5 | 34.3 | — | — |
| Laser treatment under nitrogen | 56.7 | 12.8 | 30.5 | — | — |

In light of table 1, it is apparent that:

The carbon content of the surface decreases significantly, the oxygen content of the surface increases significantly, and the nitrogen content of the surface decreases only slightly when the laser treatment takes place under an oxygen atmosphere (the surface is thus oxidized).

Under a nitrogen atmosphere, the carbon content of the surface also decreases significantly, while the nitrogen content and the oxygen content of the surface increase significantly. Because there is no oxygen present in the atmosphere, it is apparent that a significant part of the carbon reacts with the nitrogen under formation of gas.

Under an inert argon atmosphere, which cannot react with the PEEK, the carbon content of the surface increases slightly, while the nitrogen content and the oxygen content of the surface decreases slightly. It appears that the heat of the laser beam causes slight carbonization of the surface to take place.

The impurities S and Si are vaporized by the laser treatment of the surface.

### Test Conditions B

The surface was scanned twice with a pulsed laser (λ=1064 nm) in a nitrogen atmosphere at ambient pressure and temperature.

The method parameters and material constants were:

Pₚ: 10 kW; Pₘ: 3 W; f: 20 kHz; α: 45%; t: 15 ns; κ: 0.25 W/mK; d: 500 μm; v: 3000 mm/s; cₚ: 3000 J/kgK.

The value of ε=0.40, as calculated according to equation 1, lies outside the range according to the invention.

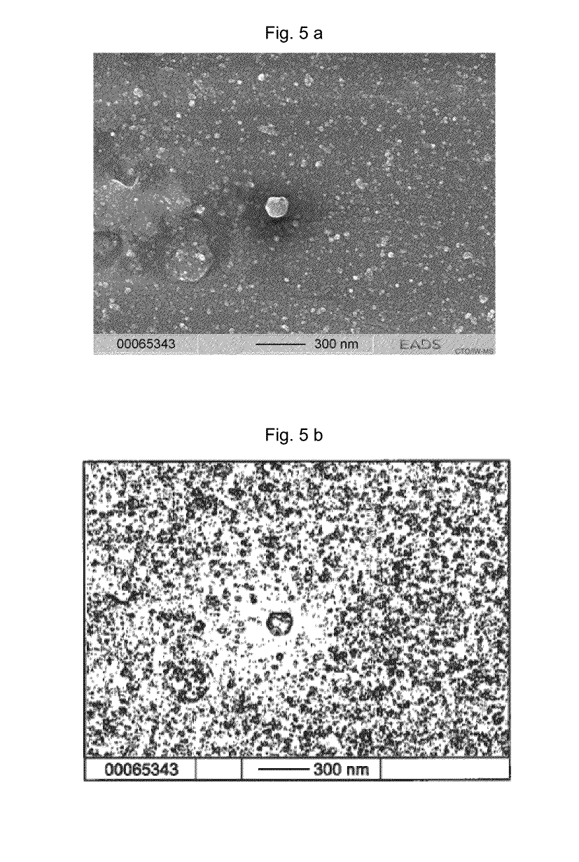

The SEM images of FIGS. 5a and 5b illustrate changes in the PEEK surface layer, but no formation of an outermost open-pored surface layer on the nanometer scale.

### Example 2

### Surface Structuring of Epoxy Resin

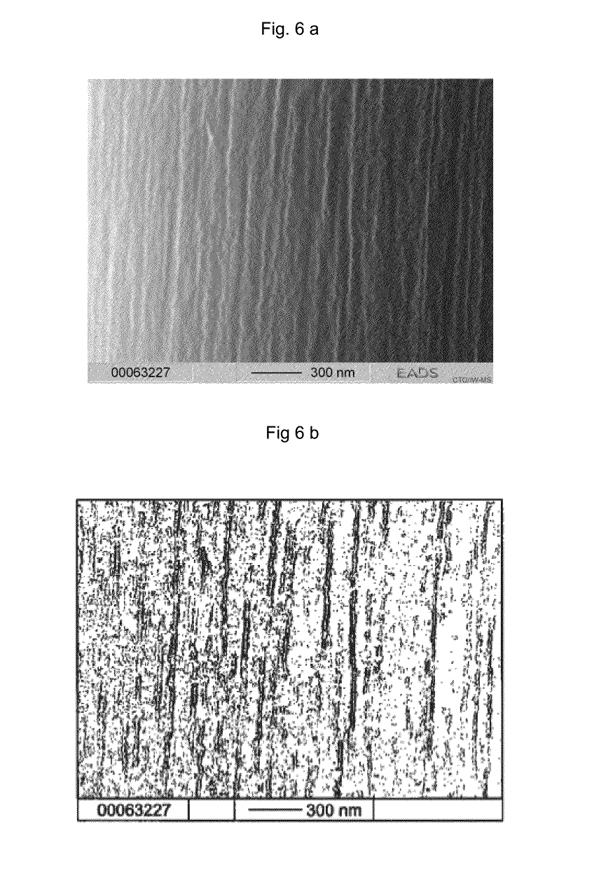

FIGS. 6a and 6b illustrate an untreated surface of epoxy resin, a thermosetting plastic.

Such surfaces were scanned with pulsed laser radiation under the following test conditions, without having been pre-treated.

### Test Conditions A

The surface was scanned three times with a pulsed laser (λ=532 nm) in an inert argon atmosphere and in a nitrogen atmosphere at ambient pressure and temperature.

The method parameters and material constants were:

Pₚ: 27 kW; Pₘ: 33 W; f: 15 kHz; α: 35%; t: 82 ns; κ: 0.19 W/mK; d: 100 μm; v: 500 mm/s; cₚ: 1500 J/kgK.

The value of ε=371, as calculated according to equation 1, lies within the range according to the invention.

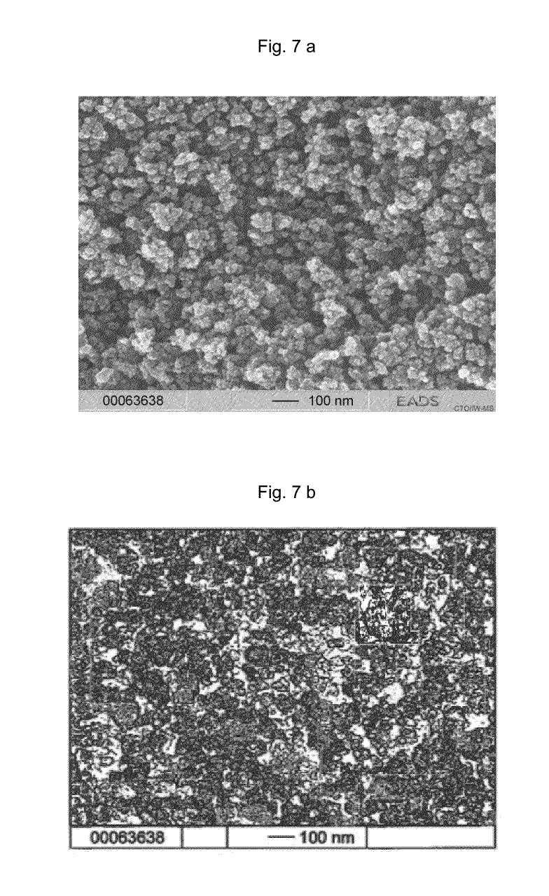

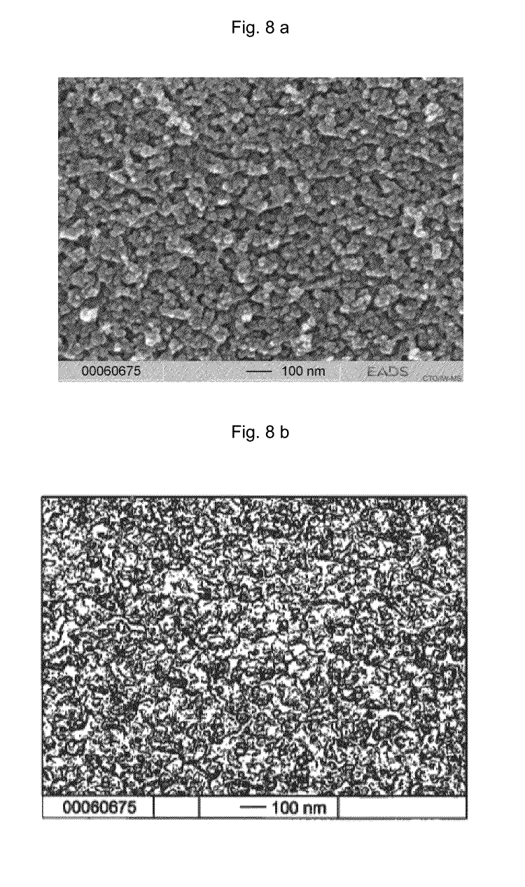

As is illustrated in plan view in the SEM images of FIGS. 7a and 7b (argon atmosphere) and FIGS. 8a and 8b (nitrogen atmosphere), the result is nanoporous epoxy resin surface layers that had a high adhesive strength to the substrate.

The elemental composition of the surfaces was analyzed after the laser treatment by means of XPS. The results are summarized in table 2 below.

TABLE 2

| | at % | | | | |
|---|---|---|---|---|---|
| Example 2 | C | N | O | Na | Cl |
| untreated | 68.0 | 2.4 | 27.4 | 1.3 | 0.9 |
| Laser treatment under argon | 78.8 | 1.8 | 19.4 | — | — |
| Laser treatment under nitrogen | 69.9 | 8.4 | 21.7 | — | — |

In light of table 2, it is apparent that:

Under an inert argon atmosphere, the carbon content of the surface increases, while the nitrogen content and the oxygen content of the surface decrease. It appears that the heat of the laser beam causes carbonization of the surface to take place, which is presumably more pronounced than in example 1 because the irradiation with the laser was performed three times.

Under a nitrogen atmosphere, the carbon content of the surface remains largely unchanged, while the nitrogen content of the surface increases and the oxygen content decreases. Nitrogen thus displaces oxygen on the surface, presumably reacting with the nitrogen in the form of gaseous nitrogen-oxygen compounds such as NO and NO2.

The impurities Na and Cl are vaporized by the laser treatment of the surface.

### Test Conditions B

The surface was scanned once with a pulsed laser (λ=1064 nm) in an oxygen atmosphere and in a nitrogen atmosphere at ambient pressure and temperature.

The method parameters and material constants were:

Pₚ: 50 kW; Pₘ: 150 W; f: 20 kHz; α: 35%; t: 150 ns; κ: 0.19 W/mK; d: 350 μm; v: 10 mm/s; cₚ: 1500 J/kgK.

The value of ε=1525, as calculated according to equation 1, does not lie within the range according to the invention.

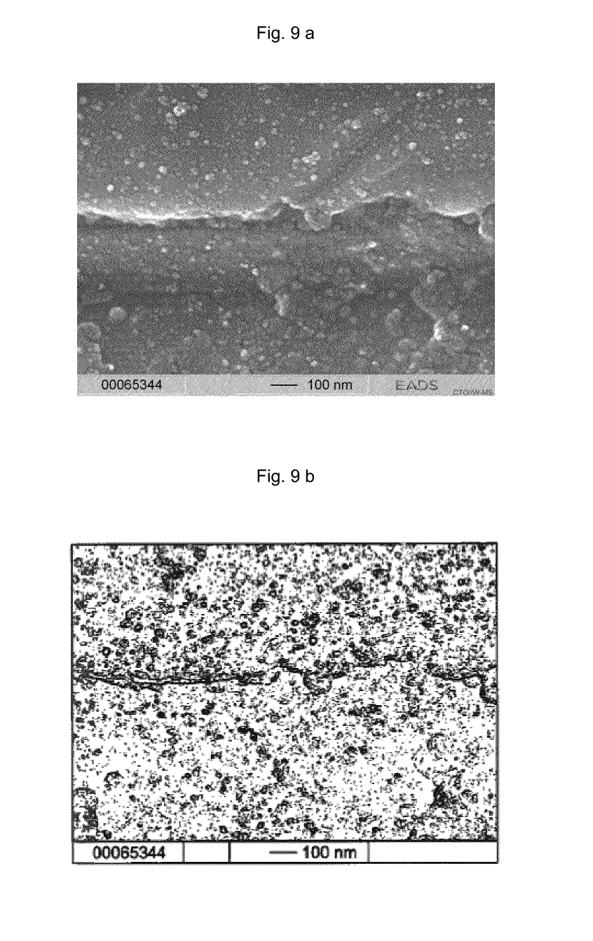

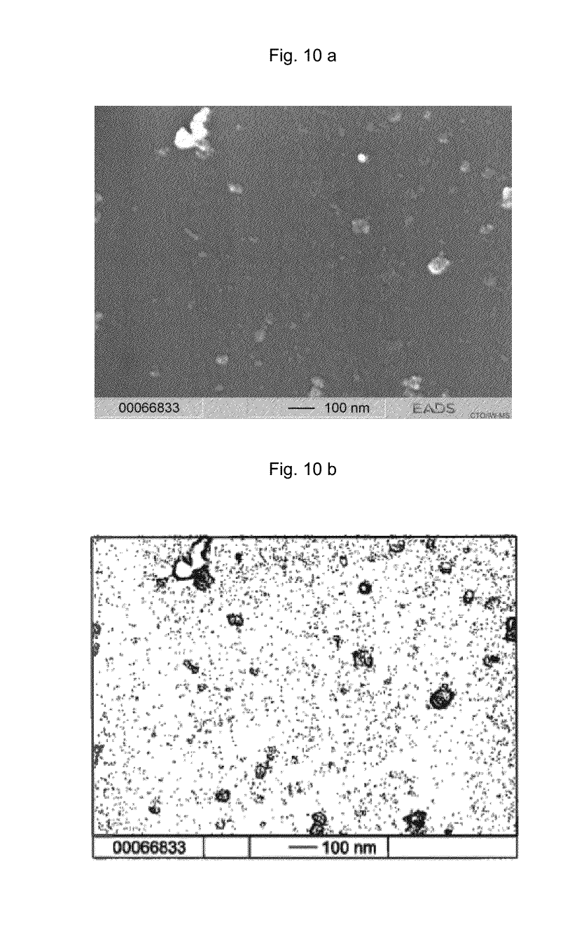

The SEM images of FIGS. 9a and 9b (oxygen atmosphere) and FIGS. 10a and 10b (nitrogen atmosphere) illustrate changes of the epoxy surface layer, but no formation of an outermost open-pore surface layer on the nanometer scale.

### Example 3

### Surface Structuring of Polyurethane

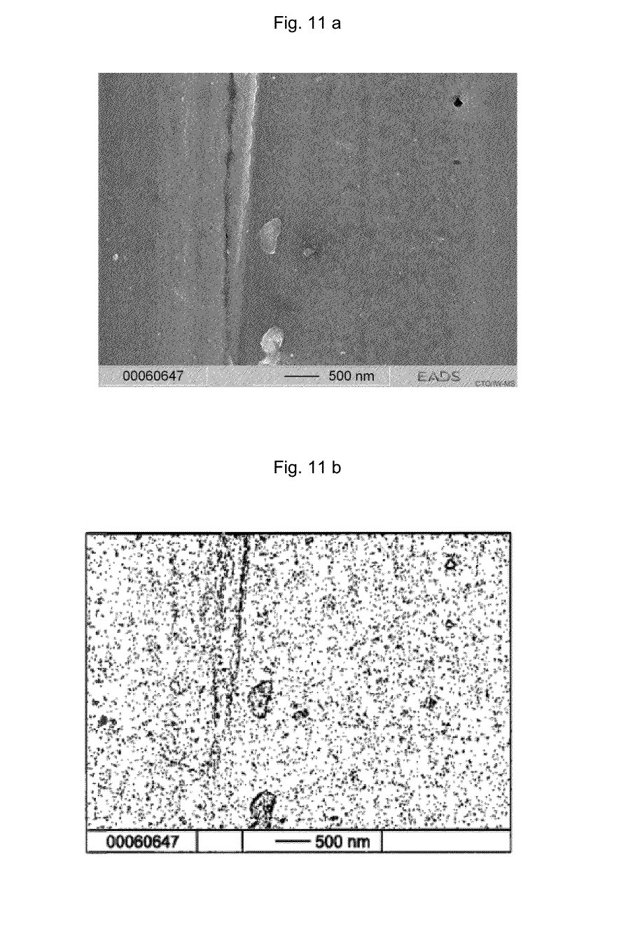

FIGS. 11a and 11b illustrate an untreated surface of polyurethane, a thermoplastic elastomer.

Such surfaces were scanned with pulsed laser radiation under the following test conditions, without having been pre-treated.

### Test Conditions A

The surface was scanned once with a pulsed laser (λ=1064 nm) in a vacuum (10⁻² mbar), and in an oxygen atmosphere and a nitrogen atmosphere at ambient pressure and temperature.

The method parameters and material constants were:

Pₚ: 10 kW; Pₘ: 3 W; f: 20 kHz; α: 45%; t: 15 ns; κ: 0.29 W/mK; d: 500 μm; v: 3000 mm/s; cₚ: 1700 J/kgK.

The value of ε=0.58, as calculated according to equation 1, lies within the range according to the invention.

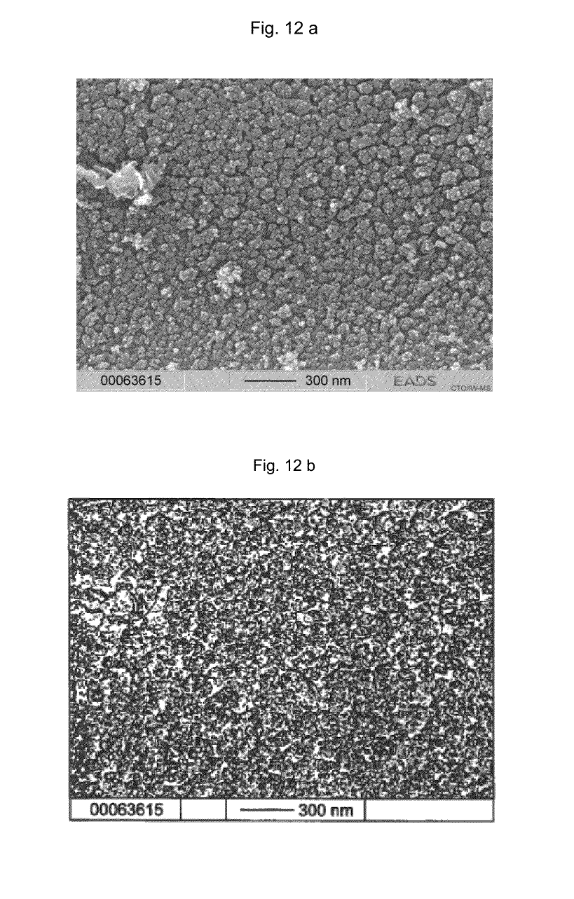

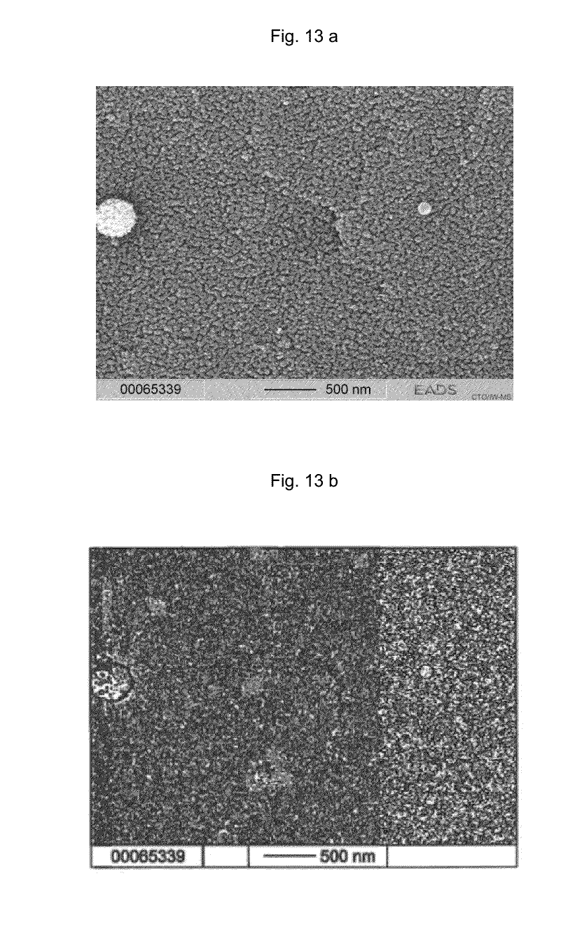

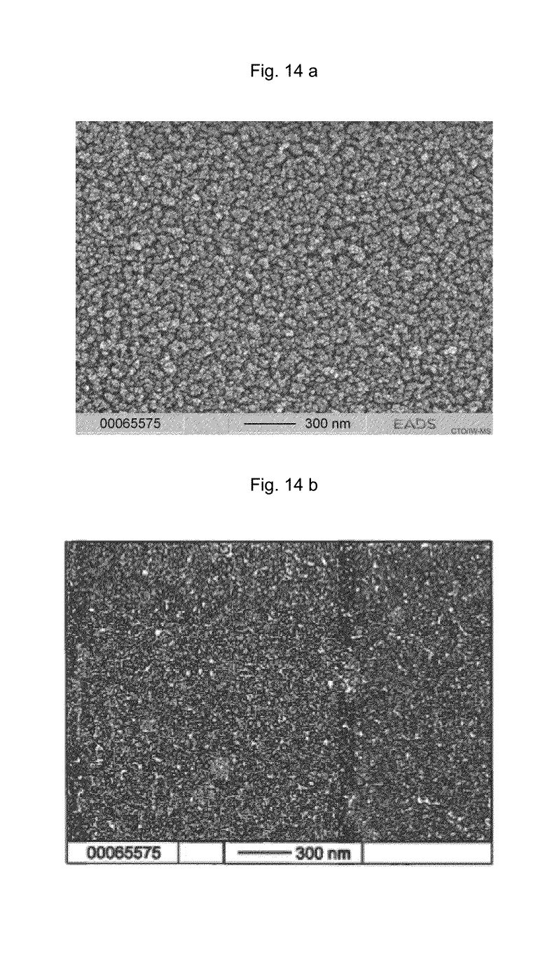

As is illustrated in plan view in the SEM images of FIGS. 12a and 12b (vacuum), FIGS. 13a and 13b (oxygen atmosphere) and FIGS. 14a and 14b (nitrogen atmosphere), the result is nanoporous epoxy surface layers that had a high adhesive strength to the substrate.

The elemental composition of the surface of the sample 3 was analyzed after the laser treatment by means of XPS. The results are summarized in table 3 below.

TABLE 3

| | at % | | | |
|---|---|---|---|---|
| Example 3 | C | N | O | Others (Na, Cl, Si) |
| untreated | 65.7 | 3.4 | 28.6 | 2.3 |
| Laser treatment under vacuum | 89.1 | 0.8 | 10.1 | — |
| Laser treatment under oxygen | 58.5 | 1.3 | 40.2 | — |
| Laser treatment under nitrogen | 60.1 | 8.7 | 30.5 | 0.7 |

In light of table 3, it is apparent that:

Under a vacuum, the carbon content of the surface increases significantly, while the nitrogen content and the oxygen content of the surface decrease significantly. It appears that the heat of the laser beam causes pronounced carbonization of the surface to take place.

The carbon content of the surface decreases, the oxygen content of the surface increases, and the nitrogen content of the surface decreases when the laser treatment takes place under an oxygen atmosphere (the surface is thus oxidized).

Under a nitrogen atmosphere, the carbon content of the surface also decreases, while the nitrogen content and the oxygen content of the surface increase. Because there is no oxygen present in the atmosphere, it is apparent that a part of the carbon reacts with the nitrogen under formation of gas.

The impurities, such as Na, Cl, and SI are largely vaporized by a laser treatment of the surface.

### Test Conditions B

The surface was scanned once with a pulsed laser (λ=1064 nm) in an oxygen atmosphere at ambient pressure and temperature.

The method parameters and material constants were:

Pₚ: 50 kW; Pₘ: 150 W; f: 20 kHz; α: 45%; t: 150 ns; κ: 0.29 W/mK; d: 350 μm; v: 10 mm/s; cₚ: 1700 J/kgK.

The value of ε=2275, as calculated according to equation 1, lies outside the range according to the invention.

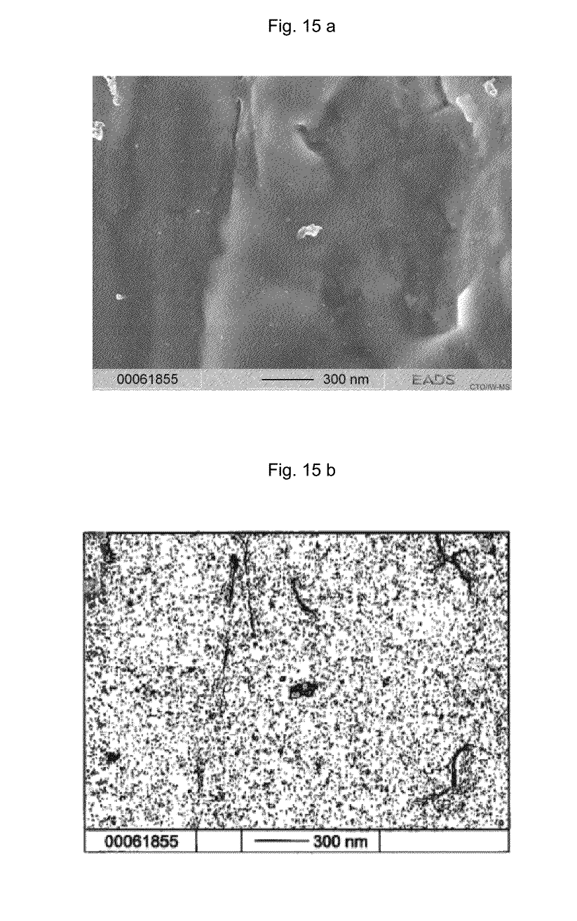

The SEM images of FIGS. 15a and 15b illustrate changes in the polyurethane surface layer but no formation of an outermost open-pored surface layer on the nanometer scale.

1-9. (canceled)

10. A method for producing a surface of a workpiece, the method comprising the acts of:
generating surface structures having dimensions in the micrometer range, wherein the surface comprises at least one solid polymeric material with which an original surface comprising the material which does not yet have surface structures having dimensions in the sub-micrometer range and is accessible to irradiation with a laser beam, by
completely scanning the surface, with a pulsed laser beam one or more times in such a manner that adjacent laser scanning spots have unbroken abutment or overlap with one another, wherein the wavelength of the laser λ is 100≦λ≦11,000 nm, and the following conditions are met:
$$0.5 \leq ɛ \leq 1350 \\ with \\ ɛ = \frac{{P}_{P} \cdot \sqrt{{P}_{m}} \cdot f \cdot α \cdot \sqrt{t} \cdot \sqrt{κ}}{{d}^{2} \cdot \sqrt{v} \cdot \sqrt{{c}_{P}}} \cdot {10}^{4} \qquad ( Equation 1 )$$
where:
Pₚ: peak pulse power of the emitted laser radiation (kW);
Pₘ: mean power of the emitted laser radiation (W);
f: Repetition rate of the laser pulses (kHz);
α: Absorption of the laser radiation by the irradiated material (%) under standard conditions;
t: pulse length of the laser pules (ns), wherein t is ≧about 0.1 ns;
κ: Specific thermal conductivity (W/mK) under standard conditions and averaged over the different spatial directions;
d: diameter of the laser beam on the workpiece (μm);
v: Scanning speed on the workpiece surface (mm/s);
cₚ: Specific heat capacity (J/kgK) under standard conditions;
wherein an atmosphere in which the method takes place is gas or a gas mixture that is reactive with respect to the surface under the method conditions, whereby the material that is comprised by the surface is chemically modified in or after the scanning of the pulsed laser beam with respect to the composition prior to the scanning with the laser beam.

11. The method according to claim 10, wherein the pressure of the atmosphere lies in the range of about 10⁻⁶ bar to about 5 bar, and the temperature of the reactive gas or gas mixture outside of the laser beam lies in the range of about −50° C. to about 100° C.

12. The method according to claim 10, wherein about 0.6≦ε≦about 1300.

13. The method according to claim 12, wherein about 0.7≦ε≦about 1250.

14. The method according to claim 10, wherein the pulse length of the irradiation t is about 0.1 ns to about 900 ns.

15. The method according to claim 14, wherein the pulse length of the irradiation t is about 0.1 ns to about 600 ns.

16. The method according to claim 10, wherein the peak pulse power of the emitted irradiation Pₚ is about 1 kW to about 1300 kW.

17. The method according to claim 16, wherein the peak pulse power of the emitted irradiation Pₚ is about 3 kW to about 650 kW.

18. The method according to claim 10, wherein the mean power of the emitted laser radiation Pₘ is about 0.2 W to about 28000 W.

19. The method according to claim 18, wherein the mean power of the emitted laser radiation Pₘ is about 1 W to about 8000 W.

20. The method according to claim 10, wherein the repetition rate of the irradiation f is about 1 kHz to about 3000 kHz

21. The method according to claim 20, wherein the repetition rate of the irradiation f is about 5 kHz to about 950 kHz.

22. The method according to claim 10, wherein the scanning speed on the workpiece surface v is about 30 mm/s to about 8000 mm/s.

23. The method according to claim 22, wherein the scanning speed on the workpiece surface v is about 200 mm/s to about 7000 mm/s.

24. The method according to claim 10, wherein the diameter of the laser beam on the workpiece d is about 20 μm to about 4500 μm

25. The method according to claim 24, wherein the diameter of the laser beam on the workpiece d is about 50 μm to about 3500 μm.
